(19) United States
(12) Patent Application Publication
(10) Pub. No.: US 2008/0228543 A1
(43) Pub. Date: Sep. 18, 2008

(54) METHODS AND APPARATUS TO COMPUTE REACH AND FREQUENCY VALUES FOR FLIGHTED SCHEDULES

(76) Inventor: Peter Campbell Doe, Ridgewood, NJ (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/048,531

(22) Filed: Mar. 14, 2008

Related U.S. Application Data
(60) Provisional application No. 60/895,292, filed on Mar. 16, 2007.

(51) Int. Cl. G06F 17/00; G06F 17/10

(52) U.S. Cl. 705/7; 703/2

(57) ABSTRACT

Methods and apparatus to compute reach and frequency values for flighted schedules are disclosed. An example method includes selecting two media components from a plurality of media components, and calculating a first flighted schedule campaign reach based on the two media components. The example method also includes repeating the selecting and calculating using the first flighted schedule campaign reach and a third media component from the plurality of media components to calculate a second flighted schedule campaign reach associated with the first, second, and third media components.

### RELATED APPLICATION

This application claims the benefit of the filing date of Provisional Patent Application Ser. No. 60/895,292, entitled “Methods and Apparatus to Compute Reach and Frequency Values for Flighted Schedules,” and filed on Mar. 16, 2007, the disclosure of which is hereby incorporated by reference in its entirety.

### FIELD OF THE DISCLOSURE

This disclosure relates generally to flighted schedules and, more particularly, to methods and apparatus to compute reach and frequency values for flighted schedules.

### BACKGROUND

Media measurement companies often generate and provide information relating to the effectiveness of various media delivery techniques to enable those companies interested in using those media delivery techniques to assess the value of (e.g., what they will pay for) using those media delivery techniques to market their products and/or services. Gross Rating Point (GRP) is one commonly used metric that may be provided by media measurement companies to convey information relating to the effectiveness of different media delivery techniques. In general, GRP represents the percentage of a population or audience that is exposed to a particular media vehicle (e.g., magazine, television, radio, newspaper, etc.), collection of media vehicles, and/or related media schedules (e.g., the times and/or frequency at which exposure occurs).

GRP is typically expressed as a product of reach (R), which generally represents the percentage of a target audience that is exposed to a single occurrence of a media vehicle, and frequency (F), which generally represents the average number of times the audience members are exposed (e.g., the number of times the media vehicle is used to repeat the advertisement, message, etc.) Thus, a GRP includes the effects of duplicate or multiple exposures and, as a result, a GRP value, by itself, can be misleading if not interpreted properly. For example, a GRP of 100 may be the result of running an advertisement having a reach of 10% ten times or, alternatively, may be the result of running an advertisement having a reach of 1% one-hundred times.

An effective advertising campaign for a product or service often involves using multiple media vehicles delivered using the same or different schedules. Oftentimes, a GRP for each of the individual media components (e.g., media vehicles and/or their associated schedules) have similar calculated values (e.g., 80), yet represent substantially different reach capabilities. For example, a first media component may have a GRP of 80 based on a 20% reach throughout four-hundred advertisement iterations. However, a second media component may have the same GRP of 80, but based on a 10% reach throughout eight-hundred advertisement iterations, thereby illustrating a lower advertising efficiency. As the costs of advertising increase, knowledge of an aggregate effect of multiple media components becomes more significant to the media measurement company that must cater to a cost judicious customer interested in purchasing a flighted schedule.

### BRIEF DESCRIPTION OF THE DRAWINGS

FIG. 1 is a schematic illustration of an example reach and frequency computing system constructed in accordance with the teachings of the invention.

FIG. 2 is a schematic illustration of an example manner of implementing the example combiner of FIG. 1.

FIG. 3 illustrates example relationships among flighted schedule reach values.

FIG. 4 is a flowchart representative of an example process that may be performed to implement the example reach and frequency computing system of FIG. 1.

FIG. 5 is a flowchart representative of an example process that may be performed to implement the example combiner and/or, more generally, the example reach and frequency computing system of FIGS. 1 and/or 2.

FIG. 6 is a schematic illustration of an example processor platform that may be used and/or programmed to perform any or all of example processes of FIGS. 4 and/or 5, and/or to implement any or all of the example apparatus and/or example methods described herein.

### DETAILED DESCRIPTION

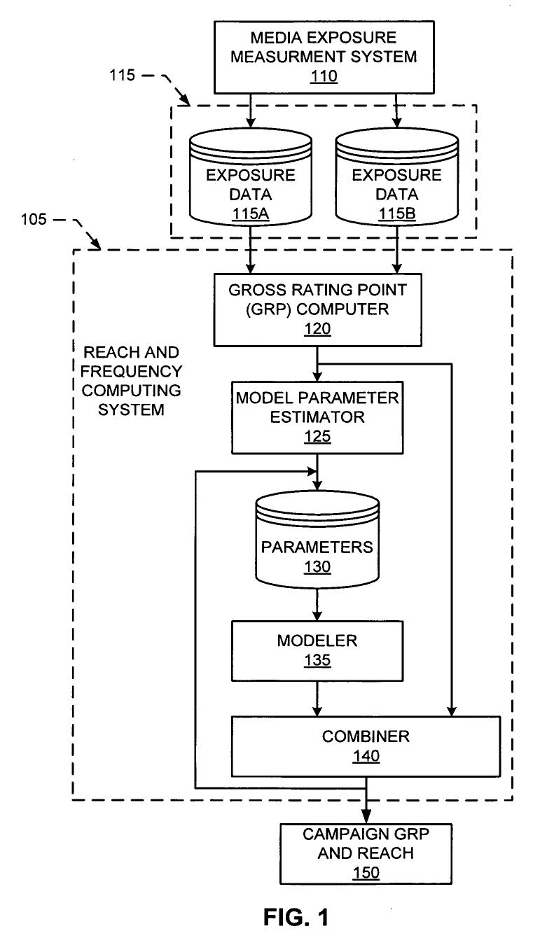

FIG. 1 illustrates an example system 105 to compute flighted schedule reach and/or frequency values for any number of media exposure measurement systems, one of which is illustrated in FIG. 1 at reference numeral 110. As used herein, the term “flighted schedule” (e.g., a marketing campaign) refers to any combination of two or more media components having different time periods (e.g., one week, two weeks, etc.) over which they may be viewed by and/or exposed to one or more persons, respondents and/or households. Example media components include any number and/or types of indoor and/or outdoor advertising sites (e.g., billboards, sides of buildings, walls of bus stops, walls of subway stations, walls of train stations, etc), commercial sites (e.g., shopping centers, shopping malls, sports arenas, etc.), television shows, commercials, print advertisements, etc. Any combination, number and/or type(s) of media components having any associated time periods may be combined to form a flighted schedule campaign. An example flighted schedule campaign includes a billboard displayed for four weeks and a bus-shelter displayed for two weeks, another example flighted schedule campaign includes a print advertisement running for one week and a television commercial broadcast for three weeks.

Any number and/or type(s) of media exposure measurement systems 110 may be used to collect exposure data for the media components of a flighted schedule campaign. Example media exposure measurement systems 110 include, but are not limited to, the Nielsen People Meter, computer based audio and/or video metering systems, outdoor media site measurement systems (e.g., using satellite positioning system receivers), and/or printed media measurement systems (e.g., using RFID tags). In general, media exposure measurement systems 110 are used, for example, by advertisers to measure and/or establish with scientific and/or verifiable accuracy the reach of their campaigns and/or media components. The media exposure measurement system 110 of FIG. 1 may record, for example, exposure data 115 representative of exposures of one or more media components to one or more persons, households and/or survey respondents during a survey time period. Such exposure data 115 may record for a particular media component which person(s) and/or respondent(s) were exposed to the media component during a time period (e.g., a nine day period). For example, exposure data 115A may be recorded for a first media site (e.g., a 30-sheet bulletin), and exposure data 115B may be recorded for a second media site (e.g., a bus shelter). Such exposure data 115, 115A, 115B may be, for example, collected during a survey period (e.g., a nine day period) and then statistically processed to compute the gross rating point (GRP), reach and/or frequency values for other time periods (e.g., one week, two weeks, etc.).

A GRP value represents the percentage of an audience exposed to a media component without regard to multiple exposures of the component to a person, respondent and/or household. For example, a GRP can be computed by factoring the number of exposures of the media component to any person, household and/or respondent (potentially including duplicated exposures) to represent the population of a designated market area (DMA), and then dividing by the size of the population (e.g., a census population count) of the DMA. A frequency value represents the average number of times respondents, households and/or persons were exposed to a media component during a specific time period (e.g., fourteen days) and, thus, represents how often respondents, households and/or persons had duplicate exposures to the media component. A reach value represents the unduplicated number of respondents, individuals and/or households exposed to a media component at least once during a reported time period (e.g., fourteen days).

The example reach and frequency computing system 105 of FIG. 1 processes the media exposure data 115 collected by the media exposure measurement system 110 and estimates, determines, computes and/or derives GRP, reach and/or frequency values for a flighted schedule campaign. Based on the survey exposure data 115 (e.g., collected during a nine day survey period), the example reach and frequency computing system 105 computes one or more GRP, reach and/or frequency values for each component of the campaign, and then combines the computed values to compute one or more GRPs, reach and/or frequency values for the overall campaign.

In some example media exposure measurement systems 110, a study participant and/or respondent carries (or wears) a satellite position system (SPS) receiver (not shown) that periodically (e.g., every 4 to 5 seconds) acquires and receives a plurality of signals transmitted by a plurality of SPS satellites (not shown) and uses the plurality of received signals to calculate a current geographic location (i.e., a position fix) for the respondent and a current time of day. The SPS receiver sequentially stores the result of each position fix (e.g., geo-code location data or geographic data, and the time of day and, if desired, the date) for later processing by a computing device (not shown). Example SPS receivers operate in accordance with one or both of the U.S. Global Positioning System (GPS) or the European Galileo System. The computing device correlates and/or compares the stored sequence of position fixes with locations of media sites to determine if one or more of the media sites should be credited with an exposure (i.e., whether it is reasonable to conclude that the wearer of the monitoring device (i.e., the SPS receiver) was exposed to the one or more media sites). Example media exposure measurement systems 110 and methods to determine exposure data 115 are described in International Publication No. WO 2006/015339, entitled “Methods and Apparatus for Improving the Accuracy and Reach of Electronic Media Exposure Measurement Systems,” and filed on Jul. 29, 2005; International Publication No. WO 2006/015188, entitled “Methods and Apparatus for Improving the Accuracy and Reach of Electronic Media Exposure Measurement Systems,” and filed on Jul. 29, 2005; and U.S. Patent Publication No. US 2004/0080452, entitled “Satellite Positioning System Enabled Media Measurement System and Method,” and filed on Oct. 16, 2003. International Publication No. WO 2006/015339, International Publication No. WO 2006/015188, and U.S. Patent Publication No. US 2004/0080452 are each hereby incorporated by reference in their entirety.

The exposure data 115 collected by the media exposure measurement system 110 may represent duplicated exposure(s) because a particular person, household and/or respondent may have passed by and/or been exposed to a particular media component more than once during a given survey period (e.g., if they live and/or work near a media site). However, duplicated exposure data 115 may be further processed (e.g., by the media exposure measurement system 110 and/or the example reach and frequency computing system 105) to obtain unduplicated exposure data wherein a media component is only credited with exposure to a particular person, respondent and/or household once during a survey period (e.g., nine days).

In the example reach and frequency computing system 105 of FIG. 1, duplicated exposure data 115 and corresponding unduplicated exposure data can be used to compute GRP, reach and/or frequency values for a particular media component. For example, duplicated exposure data 115 for the media component collected over a first time period (e.g., a nine day survey period) may be factored and then used to compute a GRP value for a second time period (e.g., two weeks). Likewise, the ratio of duplicated exposure data 115 and unduplicated exposure data for the media component may be used to compute a frequency value using, for example, a ratio of unduplicated exposure data and its corresponding duplicated exposure data 115. A reach value for the media component may be computed from the GRP and the frequency values by, for example, fitting a negative binomial distribution model to the GRP and frequency values, and then using the model to compute (e.g., estimate) the reach value for any time period (e.g., two weeks).

To compute GRP values, the example reach and frequency computing system 105 of FIG. 1 includes a GRP computer 120. Using any algorithm(s), logic and/or method(s), the example GRP computer 120 calculates a GRP value for a media component for a time period (e.g., two weeks) based upon exposure data 115 collected for the media component over another time period (e.g., nine days). As described below, GRP values computed by the example GRP computer 120 may be used in the computation of reach values for the media component and then combined with reach values for other media components to compute a flighted schedule campaign reach value.

To determine one or more parameters of a reach computation model, the example reach and frequency computing system 105 of FIG. 1 includes a model parameter estimator 125. Based upon one or more GRP and/or frequency values, and using any algorithm(s), logic and/or method(s), the example model parameter estimator 125 of FIG. 1 computes and/or estimates one or more parameters 130 of a model (e.g., a negative binomial distribution model and/or a Gamma Poisson model) that may be used to compute reach values for a desired time period (e.g., one week, two weeks, etc.). For example, the model parameter estimator 125 may compute and/or estimate the model parameters 130 by a maximum likelihood estimation process.

To implement a model for calculating reach values, the example reach and frequency computing system 105 of FIG. 1 includes a modeler 135. Using any algorithm(s), logic and/or method(s), the example modeler 135 of FIG. 1 uses model parameters 130 (e.g., negative binomial distribution parameter(s) and/or Gamma Poisson parameter(s)) estimated by the example model parameter estimator 125 to estimate reach values for a media component for a desired time period by, for example, computing one or more outputs of the model for one or more time periods.

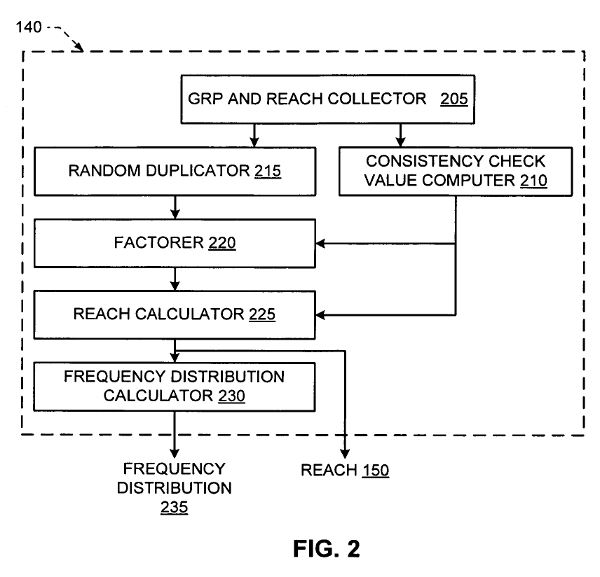

To combine reach and/or GRP values calculated for two or more media components, the example reach and frequency computing system 105 of FIG. 1 includes a combiner 140. As described below in more detail, the example combiner 140 of FIG. 1 calculates campaign GRP, reach and/or frequency values 150 based on reach and/or GRP values for two or more media components by calculating media component reach and GRP values for different time periods, using random duplication to represent duplicate exposure across the media components (e.g., a person exposed to two components of the campaign), and then factoring and combining the results. An example manner of implementing the example combiner 140 is described below in connection with FIG. 2.

To facilitate flighted schedule campaigns having three or more media components for two or more time periods, the example combiner 140 of FIG. 1 first selects the two media components associated with the shortest time periods. As used herein, the “shortness” of a media component refers to the length (e.g., in units days or weeks) of its time period (e.g., displayed for two weeks) relative to other media components of a flighted schedule campaign, and does not refer to any physical dimension associated with the media component. For example, the term “shortest component” refers to the media component of a flighted schedule campaign having the shortest time period over which it may be viewed by and/or exposed to any respondent, person and/or household. The example combiner 140 then combines the two shortest components, and then computes one or more model parameters 130 that represent their combination. That is, the two shortest components are reduced to and subsequently considered as a new single component. The model can subsequently be used to estimate reach and/or GRP values over different time periods for the combination. The combined component is then combined with the component associated with the next shortest time period, as described herein, to produce yet another combined component. Overlap between two time periods and/or between the modeled combination and the component associated with the next shortest time period can be estimated using factoring. The process of computing model parameters 130 for a combination of components, and then combining it together with the component associated with the next shortest time period may be repeated until all components have been combined.

While an example manner of implementing a reach and frequency computing system 105 has been illustrated in FIG. 1, one or more of the data structures, elements, processes and/or devices illustrated in FIG. 1 may be combined, divided, re-arranged, omitted, eliminated and/or implemented in any of a variety of ways. Further, the example GRP computer 120, the example model parameter estimator 125, the example modeler 135, the example combiner 140 and/or, more generally, the example reach and frequency computing system 105 may be implemented by hardware, software, firmware and/or any combination of hardware, software and/or firmware. Further still, the example reach and frequency computing system 105 may include data structures, elements, processes and/or devices instead of or in addition to those illustrated in FIG. 1 and/or may include more than one of any or all of the illustrated data structures, elements, processes and/or devices.

FIG. 2 illustrates an example manner of implementing the example combiner 140 of FIG. 1. To collect GRP and/or reach values for two components to be combined, the example combiner 140 of FIG. 2 includes a GRP and reach collector 205. The example collector 205 of FIG. 2 collects, obtains, and/or otherwise retrieves GRP and/or reach values for each of the two components from the example GRP computer 120 and/or the example modeler 135 of FIG. 1 for one or more time periods. The example collector 205 also collects reach values for a combination of the two components for various time periods. When the example model parameter estimator 125 and/or the modeler 135 compute a reach value for a combination of the two components, the model parameter estimator 125 and/or the modeler 135 do so without factoring in any duplicate exposures. That is, they combine the exposure data 115 for the two components without removing exposures of persons and/or households to both media components.

Consider an example flighted schedule consisting of two components: component #1 lasting four weeks (e.g., time period #2) and component #2 lasting two weeks (e.g., time period #1). The collector 205 collects a GRP value G12 for component #1 for time period #2 and a GRP value G21 for component #2 for time period #1. The campaign GRP is the sum of the two GRPs, that is, G12+G21.

The example collector 205 of FIG. 2 also collects from the modeler 135 a reach value R12 for component #1 for time period #2 (i.e., four weeks) and a reach value R21 for component #2 for time period #1 (i.e., two weeks). The collector 205 then collects from the modeler 135 a reach value R11 for component #1 for time period #1 and a reach value R22 for component #2 for time period #2. Finally, the collector 205 collects from the modeler 135 a reach value R31 for components #1 and #2 combined for time period #1, and a reach value R32 for components #1 and #2 combined for time period #2.

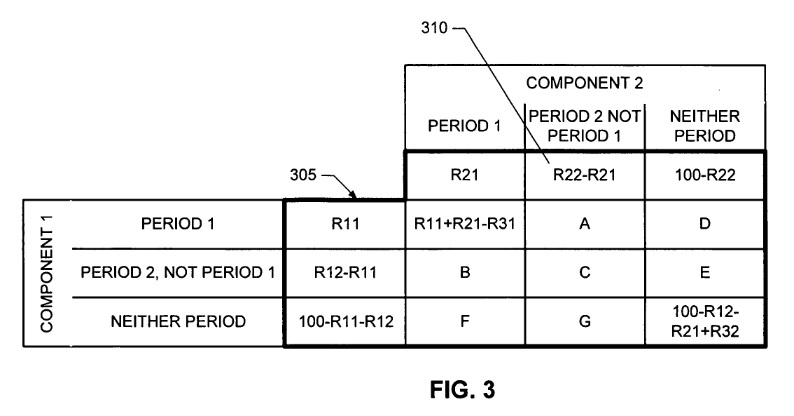

Reach values 305 for combinations of components and time periods can be represented as shown in the example data structure of FIG. 3. For example, a reach 310 for component #2 for time period #2 and not time period #1 can be computed as a difference of the reach values R22 and R21 collected by the collector 205. As described below in more detail, the values A, B and C of FIG. 3 may be computed assuming random duplication between the two components of the schedule. The values A, B, and C may then be factored to be consistent with the combined schedule, and then used to derive the values D, E, F and G of FIG. 3. Because F represents persons and/or households reached by component #2 in time period #1 who were not reached by component #1 in either time period, the overall flighted schedule campaign reach 150 may be computed as the sum of R12 and F (i.e., R12+F).

Returning to FIG. 2, to ensure consistency in the results, the example combiner 140 of FIG. 2 includes a consistency check value computer 210. The example consistency check value computer 210 calculates parameters k1 and k2 that represent an estimate of the combined reach value for each time period. The values k1 and k2 can be computed as

k1=max{0,R11+R21−R31}

k2=max{0,R12+R22−R32} EQN (1)

where max { } represents the mathematical maximum operator.

To estimate exposure duplication among the components, the example combiner 140 of FIG. 2 includes a random duplicator 215. Assuming random duplication of exposure between the two components, the example duplicator 215 computes the example values A, B and C of FIG. 3. For example, the values A, B and C can be computed using the mathematical expression of EQN (2).

A=R11(R22−R21)/100

B=R21(R12−R11)/100

C=(R12−R11)R22−R21)/100

k3=A+B+C EQN (2)

To factor the values A, B and C, the example combiner 140 of FIG. 2 includes a factorer 220. The example factorer 220 of FIG. 2 factors the values A, B and C to be consistent with the combined reach values collected by the collector 205. For example, the values A, B and C can be factored as shown below.

k4=(k2−k1)/k3

A=A*k4

B=B*k4

C=C*k4 EQN (3)

To calculate the flighted schedule campaign reach, the example combiner 140 of FIG. 2 includes a reach calculator 225. The example reach calculator 225 of FIG. 2 derives the example values D, E, F and G of FIG. 3 based on the values A, B, C and the combined reach values collected by the collector 205 by computing appropriate differences such as, for example, those expressed in EQN (4).

D=R11−k1−A

E=R12−R11−B−C

F=R21−k1−B

G=R22−R21−A−C EQN (4)

Because F represents persons and/or households reached by component #2 in time period #1 who were not reached by component #1 in either time period, the overall flighted schedule campaign reach 150 may be computed as the sum of R12 and F (i.e., R12+F).

To compute a frequency distribution 235, the example combiner 140 of FIG. 2 includes a frequency distribution calculator 230. Using any algorithm(s), logic and/or method(s), the example frequency distribution calculator 230 of FIG. 2 fits a negative binomial distribution model to the combined schedule using the campaign reach 150 computed by the reach calculator 224 and the campaign GRP (e.g., G12+G21) as inputs. When fitting the negative binomial distribution to the combined schedule, the frequency distribution calculator 230 need not adjust the parameters because the inputs are final values, and uses a unit of time value of 1.

While an example manner of implementing the example combiner 140 of FIG. 1 has been illustrated in FIG. 2, one or more the elements, processes and devices illustrated in FIG. 2 may be combined, divided, re-arranged, omitted, eliminated and/or implemented in any of a variety of ways. Further, the example GRP and reach collector 205, the example consistency check value computer 210, the example random duplicator 215, the example factorer 220, the example reach calculator 225, the example frequency distribution calculator 230 and/or, more generally, the example combiner 140 may be implemented by hardware, software, firmware and/or any combination of hardware, software and/or firmware. Further still, the example combiner 140 may include elements, processes and/or devices in addition to those illustrated in FIG. 2 and/or may include more than one of any or all of the illustrated elements, processes and devices.

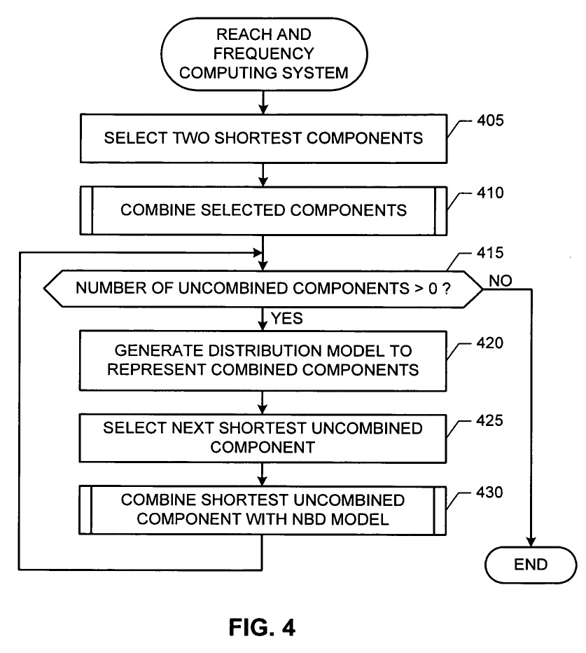

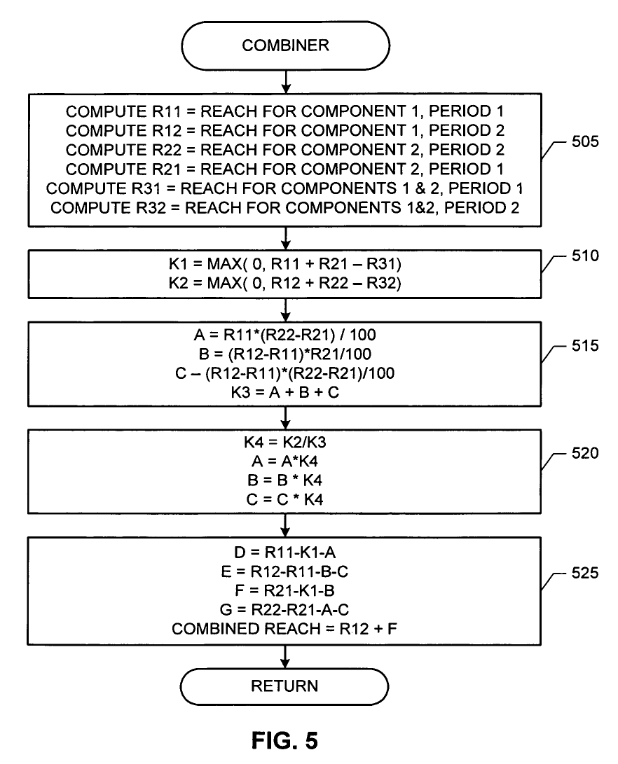

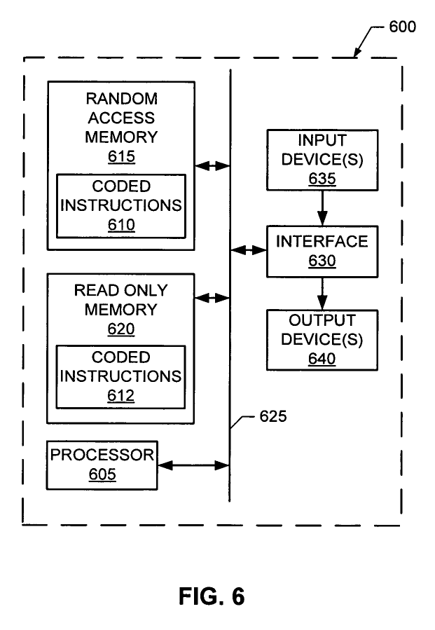

FIG. 4 is a flowchart representative of an example process that may be performed to implement the example reach and frequency computing system 105 of FIG. 1. FIG. 5 is a flowchart representative of an example process that may be performed to implement the example combiner 140 and/or, more generally, the example reach and frequency computing system 105 of FIGS. 1 and/or 2. The example processes of FIGS. 4 and/or 5 may be carried out by a processor, a controller and/or any other suitable processing device. For example, the example processes of FIGS. 4 and/or 5 may be embodied in coded instructions stored on a tangible medium such as a flash memory, a read-only memory (ROM) and/or random-access memory (RAM) associated with a processor (e.g., the example processor 605 discussed below in connection with FIG. 6). Alternatively, some or all of the example operations of FIGS. 4 and/or 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example operations of FIGS. 4 and/or 5 may be implemented manually or as any combination of any of the foregoing techniques, for example, any combination of firmware, software, discrete logic and/or hardware. Further, although the example processes of FIGS. 4 and 5 are described with reference to the flowcharts of FIGS. 4 and 5, many other methods of implementing the processes of FIGS. 4 and/or 5 may be employed. For example, the order of execution of the blocks may be changed, and/or one or more of the blocks described may be changed, eliminated, sub-divided, or combined. Additionally, any or all of the example operations of FIGS. 4 and/or 5 may be carried out sequentially and/or carried out in parallel by, for example, separate processing threads, processors, devices, discrete logic, circuits, etc.

The example process of FIG. 4 begins with a reach and frequency computing system (e.g., the example reach and frequency computing system 105 of FIG. 1) by identifying and selecting the two shortest components of a flighted schedule campaign (block 405). In other words, the two shortest components of the flighted schedule campaign operate as seed components for the example process of FIG. 4. For example, the GRP and reach collector 205 of FIG. 2 collect any number of components that comprise a flighted schedule and identify a corresponding rank order for each component based on its time period (duration). The reach and frequency computing system combines the two shortest components by, for example, performing the example process of FIG. 5 (block 410).

If the number of uncombined components is zero (block 415), control exits from the example process of FIG. 4. If the number of uncombined components is greater than zero (block 415), the reach and frequency computing system fits a negative binomial distribution model to the already formed combination (block 420), thereby generating a modeled combination. The reach and frequency computing system then selects the next shortest uncombined component (block 425) and combines the selected component with the modeled combination by, for example, performing the example process of FIG. 5 (block 430). Control then returns to block 415 to determine if more components need to be combined.

The example process of FIG. 5 begins when a combiner (e.g., any or all of the example combiner 140 of FIGS. 1 and/or 2) is to combine two components (e.g. when called by the example process of FIG. 4 at block 410 and/or block 430). The combiner 140 (e.g., the example GRP and reach collector 205 of FIG. 2) collects reach values (e.g., R11, R12, R21, R22, R31 and R32) from a reach modeler (e.g., the example modeler 135 of FIG. 1) (block 505). The combiner 140 (e.g., the example consistency check value computer 210) then calculates factors k1 and k2 that may be used to verify that a computed campaign reach is consistent with the collected combined reach values (block 510).

Assuming random duplication of exposure between the components, the combiner 140 (e.g., the example random duplicator 215 of FIG. 2) computes the example values A, B and C of FIG. 3 (block 515). The combiner 140 (e.g., the example factorer 220) factors the values A, B and C based on the consistency check values k1 and k2 (block 520). The combiner (e.g., the example reach calculator 225) then derives the flighted schedule campaign reach as a sum of R12 and F, where F is computed using, for example, EQN (4) (block 525). Control then returns to, for example, the example process of FIG. 4 at block 410 and/or block 430. In some instances, the derived flighted schedule campaign (block 525) operates as an intermediate flighted schedule campaign reach value when the example process of FIG. 4 returns to block 410. In other instances, the derived flighted schedule campaign reach value is updated during each iteration of the example process of FIG. 4 based on one or more combined/selected components (block 415) of the flighted schedule campaign. Accordingly, a derived flighted schedule campaign reach value during a final iteration of the example process of FIG. 4 represents a final flighted schedule campaign reach.

FIG. 6 is a schematic diagram of an example processor platform 600 that may be used and/or programmed to implement any portion(s) and/or all of the example reach and frequency computing system 105 of FIG. 1. For example, the processor platform 600 can be implemented by one or more general purpose processors, processor cores, microcontrollers, etc.

The processor platform 600 of the example of FIG. 6 includes at least one general purpose programmable processor 605. The processor 605 executes coded instructions 610 and/or 612 present in main memory of the processor 605 (e.g., within a RAM 615 and/or a ROM 620). The processor 605 may be any type of processing unit, such as a processor core, a processor and/or a microcontroller. The processor 605 may execute, among other things, the example processes of FIGS. 4 and/or 5 to implement any or all of the example reach and frequency computing systems 105 and/or the example combiner 140 described herein. The processor 605 is in communication with the main memory (including a ROM 620 and/or the RAM 615) via a bus 625. The RAM 615 may be implemented by DRAM, SDRAM, and/or any other type of RAM device, and ROM may be implemented by flash memory and/or any other desired type of memory device. Access to the memory 615 and 620 may be controlled by a memory controller (not shown). The RAM 615 may be used to store and/or implement, for example, the example exposure data 115 and/or the example parameters 130 of FIG. 1.

The processor platform 600 also includes an interface circuit 630. The interface circuit 630 may be implemented by any type of interface standard, such as a USB interface, a Bluetooth interface, an external memory interface, serial port, general purpose input/output, etc. One or more input devices 635 and one or more output devices 640 are connected to the interface circuit 630. The input devices 635 and/or output devices 640 may be used to receive the exposure data 115 and/or to output the example outputs 150 of FIG. 1.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to calculate a flighted schedule campaign reach comprising:
selecting two media components from a plurality of media components;
calculating a first flighted schedule campaign reach based on the two media components; and
repeating the selecting and calculating using the first flighted schedule campaign reach and a third media component from the plurality of media components to calculate a second flighted schedule campaign reach associated with the first, second, and third media components.

2. A method as described in claim 1, further comprising fitting the first flighted schedule campaign reach to a distribution model to compute the first flighted schedule campaign reach based on at least two time periods.

3. A method as described in claim 2, wherein fitting the first flighted schedule campaign reach to the distribution model comprises fitting to at least one of a negative binomial distribution model, a Gamma Poisson model, or a maximum likelihood estimation process.

4. A method as defined in claim 1, further comprising identifying a rank order of the plurality of media components based on a corresponding time period of each of the plurality of media components.

5. A method as defined in claim 4, wherein selecting the third media component comprises selecting one of the ranked plurality of media components having the shortest third duration.

6. A method as defined in claim 1, wherein the selected two media components comprise the two shortest durations of the ranked plurality of media components.

7. A method as defined in claim 1, wherein calculating the first flighted schedule campaign reach further comprises:
computing an individual reach value for each of the two media components;
computing a combined reach component based on the individual reach values; and
calculating at least one factor associated with the combined reach component to verify consistency with the first flighted schedule campaign reach.

8. A method as defined in claim 7, further comprising calculating at least one difference value for each of the two media components based on at least one time period associated with each media component.

9. A method as defined in claim 8, further comprising applying the at least one factor to each of the at least one difference values to verify consistency of the difference values and the first flighted schedule campaign reach.

10. A method as defined in claim 9, further comprising deriving at least one reach value of the two media components associated with unreached time periods.

11. An apparatus to calculate a flighted schedule campaign reach comprising:
a collector to collect reach values associated with a first and second media components from a plurality of media components;
a duplicator to calculate reach value differences of the collected reach values to estimate exposure duplication; and
a reach calculator to iteratively calculate the flighted schedule campaign reach based on the reach value differences and another media component from the collector.

12. An apparatus as defined in claim 11, further comprising a gross rating point (GRP) computer to calculate at least one GRP value based on media component exposure data, and wherein the collector is to collect the at least one GRP value.

13. An apparatus as defined in claim 11, wherein the collector is to arrange the collected reach values in a rank order based on a time period associated with each of the plurality of media components.

14. An apparatus as defined in claim 13, wherein the collector is to select the first and second media components based on a minimum time period in the rank order.

15. An apparatus as defined in claim 11, further comprising a consistency check computer to calculate at least one parameter to estimate a combined reach value of the first and second media components.

16. An apparatus as defined in claim 15, further comprising a factorer to apply the at least one parameter to the reach value differences to verify consistency with the reach value differences.

17. A method to calculate a flighted schedule campaign comprising:
selecting first and a second media components from a plurality of media components;
calculating a first combined reach of the first and second media components;
fitting the first combined reach to a distribution model;
selecting a third media component from the plurality of media components; and
calculating a second combined reach based on the first combined reach and the third media component.

18. A method as defined in claim 17, further comprising, when the plurality of media components comprises a fourth media component:
fitting the second combined reach to the distribution model;
selecting the fourth media component; and
calculating a third combined reach based on the second combined reach and the fourth media component.

19. A method to calculate a flighted schedule campaign comprising:
identifying a first media component from a plurality of media components, the first media component comprising a first shortest time period;
identifying a second media component from the plurality of media components, the second media component comprising a second shortest time period;
combining the first and second media components to calculate a reach value for each of the first and second time periods;
calculating a first flighted schedule campaign reach based on the combined media components; and
fitting a model parameter to the first flighted schedule campaign.

20. An article of manufacture storing machine accessible instructions that, when executed, cause a machine to:
select two media components from a plurality of media components;
calculate a first flighted schedule campaign reach based on the two media components; and
repeat the selecting and calculating using the first flighted schedule campaign reach and a third media component from the plurality of media components to calculate a second flighted schedule campaign reach associated with the first, second, and third media components.

21. An article of manufacture as defined in claim 20, wherein the machine accessible instructions further cause the machine to fit the first flighted schedule campaign reach to a distribution model to compute the first flighted schedule campaign reach based on at least two time periods.

22. An article of manufacture as defined in claim 21, wherein the machine accessible instructions further cause the machine to fit at least one of a negative binomial distribution model, a Gamma Poisson model, or a maximum likelihood estimation process.

23. An article of manufacture as defined in claim 20, wherein the machine accessible instructions further cause the machine to identify a rank order of the plurality of media components based on a corresponding time period of each of the plurality of media components.

24. An article of manufacture as defined in claim 23, wherein the machine accessible instructions further cause the machine to select one of the ranked plurality of media components having the two shortest durations.

25. An article of manufacture as defined in claim 20, wherein the machine accessible instructions further cause the machine to:
compute an individual reach value for each of the two media components;
compute a combined reach component based on the individual reach values; and
calculate at least one factor associated with the combined reach component to verify consistency with the first flighted schedule campaign reach.

26. An article of manufacture as defined in claim 25, wherein the machine accessible instructions further cause the machine to calculate at least one difference value for each of the two media components based on at least one time period associated with each media component.

27. An article of manufacture as defined in claim 26, wherein the machine accessible instructions further cause the machine to apply the at least one factor to each of the at least one difference values to verify consistency of the difference values and the first flighted schedule campaign reach.

28. An article of manufacture as defined in claim 27, wherein the machine accessible instructions further cause the machine to derive at least one reach value of the two media components associated with unreached time periods.
